(19) United States
(12) Patent Application Publication
(10) Pub. No.: US 2010/0242501 A1
(43) Pub. Date: Sep. 30, 2010

(54) Cooling System

(76) Inventors: Laura L. Li, Altadena, CA (US); Guang Shun Li, Mian Yang (CN); Meng Chu Li, Mian Yang (CN)

Correspondence Address: DAPHNE BURTON, 2029 CENTURY PARK EAST, SUITE 1400, LOS ANGELES, CA, 90067, US

(21) Appl. No.: 12/411,979

(22) Filed: Mar. 26, 2009

(51) Int. Cl. F25B 19/00; F25D 17/06; C09K 5/00

(52) U.S. Cl. 62/51.1; 62/426; 62/114

(57) ABSTRACT

An energy efficient cooling system that employs liquid air in order to eliminate potentially harmful effects associated with some refrigerants with regard to both humans and the environment. The system includes an insulated container configured to contain liquid air at the appropriate low temperature so that it can remain in its liquefied state. The system further includes at least one air flow device, which may be a compressor and/or a fan. The system also includes a valve-controlled piping system for moving the cool air to an outlet, such as a duct system. Thereafter, the cool air may be distributed throughout a room, building or other area for which cooling is desired.

### BACKGROUND OF THE INVENTION

1. Field of Invention

The present disclosure relates generally to cooling systems and, more particularly, to an energy efficient, environmentally friendly cooling system that provides for a significant range of cooling without the use of harmful refrigerants.

2. Description of Related Art.

Cooling systems, such as air conditioners and heat pumps, are often used in indoor spaces to provide temperature control. Air conditioners remove heat from a space, and cycle the previously warm air back into the space as cooler air. Many air conditioners include a compressor, “hot” coils, “cold” coils and an expansion valve.

When an air conditioner is in operation, the compressor compresses cool gas-form refrigerant, thus causing the refrigerant to become a hot, high-pressure gas. The hot gas traverses the “hot” coils, thus causing the hot gas to dissipate heat, and the gas condenses into a liquid. This liquid traverses an expansion valve, causing it to evaporate and become a cold, low-pressure gas form refrigerant. The cold gas-form refrigerant traverses the “cold” coils, thus allowing the refrigerant to absorb heat and reduce the temperature in the space desired.

Air conditioners have certain drawbacks in that they do not consume energy in an efficient manner. When an air conditioner is running, its refrigerant is continuously being boiled from a liquid to a gas, and condensed back into a liquid again. This boil/condense cycle requires a significant amount of energy. Also, as discussed in greater detail hereinbelow, air conditioners often use refrigerants which are harmful to both the environment and humans.

Heat pumps are also commonly used, and are sometimes said to provide greater energy efficiency than air conditioners. Heat pumps may be used as cooling systems by absorbing heat from indoor air and moving the heat to the outdoors. A heat pump-based system may include a compressor, a refrigerant, an indoor coil, an outdoor coil and an expansion valve.

Heat pump systems may operate under many of the same principles as air conditioners. In such heat-pump based cooling systems, the compressor may compress a cool gas-form refrigerant. The compressor may cause the refrigerant becomes a hot, high-pressure gas. The hot gas may traverse the indoor coil which has been cooled by the refrigerant, thus dissipating the heat from the gas. Then the gas may be condensed into a liquid. The liquid form refrigerant may go through an expansion valve, whereupon it may evaporate to become cold, low-pressure gas. The cold gas may then traverse a set of coils, thus permitting the gas to absorb heat and cool the air inside the desired space.

It should be noted that heat pump cooling systems may be used in two modes: in a first mode it may act as a cooling system; in a second mode, it may act as a heating system. More particularly, the heat pump may include a valve that reverses the flow of refrigerant, thus allowing the heat pump to serve as a heating system.

Heat pumps also have certain drawbacks. Although these heat pump systems may be more energy efficient than air conditioners, they still require a significant amount of energy. There is a need for a cooling system that requires less energy.

Moreover, both heat pump systems and air conditioners suffer from drawbacks in that the refrigerants used in such systems may be damaging to both the environment and humans. In the past, refrigerants such as R-12 (also known as Freon 12) were used. This refrigerant is a chlorofluorocarbon halomethane (CFC). The United States and many other countries have banned its manufacture because of concerns about its damage to the ozone layer.

Another common refrigerant is refrigerant R-22 (also known as monochlorodifluoromethane). This refrigerant R-22 is a synthetic refrigerant that may be used in refrigeration systems that require a low-evaporating temperature. This refrigerant is expected to be phased out in the United States because of its ozone depletion potential and its status as a potent greenhouse gas.

Still another common refrigerant is R-502. This refrigerant R-502 is an azeotropic mixture of about 48.8% R-22 and 51.2% R-115. This refrigerant has also been determined to contribute to ozone depletion.

Yet still another common refrigerant for cooling systems is R-134a (also known as tetrafluoroethane). This refrigerant has been linked to the greenhouse effect. It has also been the subject of use restrictions due to its potential contribution to climate change. In the European Union, this refrigerant R-134a is expected to be banned from 2011 in all new cars. Moreover, the state of California may prohibit the sale of the canned form of this refrigerant to individuals in order to avoid non-professional recharge of air conditioners.

Another refrigerant, R-717 Ammonia (NH3), has been linked to lung damage and death when used in high concentrations. Moreover, in the United States, ammonia fits within the definition of a material that is toxic by inhalation and requires a hazardous safety permit when transported in quantities that exceed a certain specified threshold.

Refrigerant R-125 (also known as pentafluoroethane) may be used as a refrigerant in low- and medium-temperature applications. Although R-125 has been said to have zero ozone depletion potential, its use has high global warming potential. By some estimates, it has the global warming potential that is 3,400 times that of carbon dioxide over a 100-year period.

Lithium bromide (LiBr) is used in air conditioning systems as a desiccant in order to sustain a state of dryness. Lithium bromide is toxic to humans in that it may adversely affect the central nervous system. It may also cause cardiac disturbances and/or kidney damage.

There is a need for a cooling system that is safer for both humans and the environment.

### BRIEF SUMMARY OF DISCLOSURE

The present disclosure addresses the foregoing deficiencies of the prior art by providing a cooling system that is relatively energy efficient, and does not use refrigerants that are harmful to humans and the environment.

In accordance with one embodiment of the present disclosure, a non-toxic, energy efficient cooling system is provided. The system comprises liquid air and a container device configured to contain the liquid air and to maintain the liquid air in its liquefied form. The system further comprises an outlet, a cooled air conduit configured to provide a conduit for the cooled gas-form air from the container device to the outlet via the cooled air conduit, and at least one air flow device configured to cause the flow of the cooled gas-form air from the container device to the outlet via the cooled air conduit, and wherein, the container device is further configured to permit the flow of the cooled gas-form air from the container device to the outlet.

In accordance with another embodiment of the present disclosure, a non-toxic, energy efficient cooling system is provided. The system comprises liquid air and an insulated container device configured to contain the liquid air and to maintain the liquid air in its liquefied form. The system further comprises an outlet, and a compressor device configured to introduce gas-form air into the insulated container device, thus causing some of the air in the insulated container device to rise and exit the container device as cooled gas-form air. The compressor device is further configured to push the cooled gas-form air from the container device to the outlet. The compressor device is coupled to the bottom quadrant of the reservoir for the insulated container device. The system further comprises a cooled air conduit configured to provide a conduit without coils for the cooled gas-form air from the insulated container device to the outlet.

The system still further comprises a fan device configured to draw the cooled gas-form air from the insulated container device to the outlet via the liquid air conduit, and at least two valve devices configured to permit the pushing and drawing of air from the insulated container device to the outlet via the cooled air conduit. The system further comprises at least two valve devices configured to permit the pushing and drawing of the cooled gas-form air from the insulated container device to the outlet via the cooled air conduit. The insulated container device is further configured to provide sufficient capacity for the release of cooled gas-form air from the insulated container device.

In accordance with yet another embodiment of the present disclosure, a non-toxic, energy efficient method for cooling an area is provided. The method comprises the steps of providing liquid air in an insulated container; wherein the insulated container is configured to contain the liquid air and to maintain the liquid air in its liquefied form.

The method further comprises opening a first valve mechanism positioned on a first conduit segment between the insulated container and an outlet, thus permitting the flow of cooled gas-form air from the insulated container to the outlet.

The method still further comprises opening a second valve mechanism positioned on a second conduit segment between a compressor and the insulated container, thus permitting the flow of air from the compressor to the insulated container.

The method also comprises causing the flow of the cooled gas-form air from the insulated container to the outlet, thus cooling an area located at the outlet.

These, as well as other objects, features and benefits will now become clear from a review of the following detailed description of illustrative embodiments and the accompanying drawings.

### BRIEF DESCRIPTION OF DRAWINGS

FIG. 1 is a cooling system in accordance with one embodiment of the present disclosure.

FIG. 2 is a compressor-based cooling system in accordance with yet another embodiment of the present disclosure.

FIG. 3 is a fan-based cooling system in accordance with still yet another embodiment of the present disclosure.

### DETAILED DESCRIPTION OF THE DISCLOSURE

The cooling system of the present disclosure provides for energy efficiency and reduced toxicity to both humans and the environment.

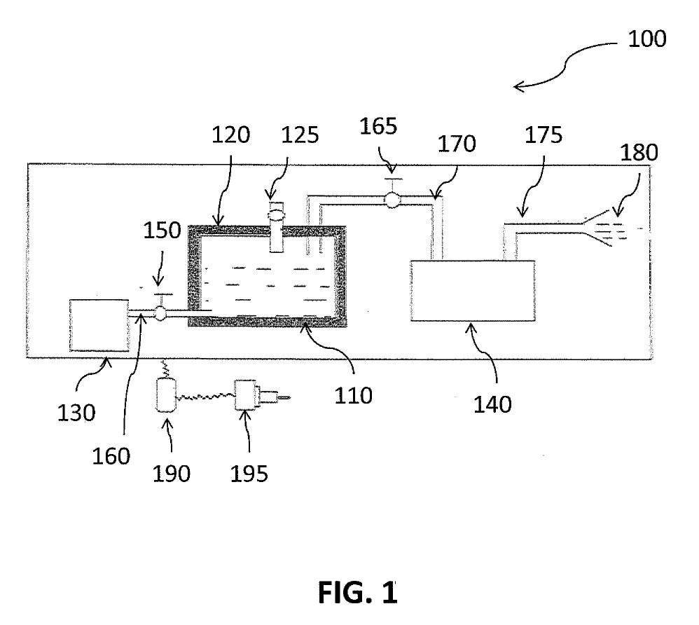

Referring now to FIG. 1, illustrated is a cooling system 100 in accordance with one embodiment of the present disclosure. As shown, the cooling system 100 comprises liquid air 110 disposed within an insulated container 120.

Liquid air is everyday air that has been compressed and cooled to an extremely low temperature, thus changing its state from a gas to a liquid. Commercially, liquid air may be obtained through various processes. For example, the ordinary air may be washed in order to remove impurities. This air may also be subjected to lime (also known as calcium oxide) in order to remove the carbon dioxide that is present in today's environment. This gaseous air may be compressed using significant pressure (e.g., 2,500-3,000 pounds per square inch). It may then be cooled, e.g., by passing it through cooled pipes which may be disposed in cold water. Thereafter, the expanded air may be passed back over the cooled pipes from which it has been released, thus absorbing a sufficient amount of heat such that air remaining in the pipe becomes a liquid. This liquefaction may result in a liquid air composition that is about 78.1% nitrogen, 21.0% oxygen, 0.9% argon and relatively extremely small amounts of other gases.

The insulated container 120 that contains the liquid air 110 may be a cryogenic storage container or other container configured to maintain the liquid air in its liquefied form. The insulated container 120 may include an inner vessel and an outer vessel, separated by a vacuum. The inner vessel of insulated container 120 may include a reservoir for storage of the liquid air 110. The vacuum space of the insulated container 120 may maintain the liquid air at a temperature that is much lower than the surrounding environment. The container 120 may also include pressure relief valves and/or rupture disks designed to guard the cylinders from damage associated with excess pressure.

It is desirable to keep liquid air at a temperature below −195.8° C. since, as the temperature of liquid air rises, the nitrogen evaporates first at about −195.8° C., the argon next at about −185.7° C., and the oxygen last at about −183° C. To provide greater insulation properties, the container 120 may be wrapped with a flexible insulation material. Insulated container 120 may include a liquid air introduction valve 125 that permits the introduction of additional liquid air into the insulated container 120 when needed or desired.

As shown in FIG. 1, the cooling system 100 may also include a compressor 130. A valve-controlled pipe 160 may be disposed between the compressor 130 and insulated container 120. The compressor 130 may draw upon gas-form air from the surrounding environment and introduce that gas-form air into the insulated container 120 along valve-controlled pipe 160 by opening valve 150. Of course, by closing the valve-controlled pipe 160, the flow of air between the compressor 130 and insulated container 120 may be brought to a halt. When gas-form air that flows from compressor 130 to insulated container 120 has been introduced into the insulated container 120 containing the liquid air, it may cause the flow of cooled gas-form air from the insulated container 120 through a second pipe 170 toward outlet 180 when valve 165 is open. It should be noted that when the higher-temperature gas-form air enters the insulated container 120, it pushes the liquid air 110 upward. At that point, cooled gas-form air emerges at the top of the insulated container 120. Accordingly, it may be desirable that the insulated container 120 not be filled to its full capacity since there should be space at the top of the container 120 for the cooled gas-form air to accumulate at the top of the container 120. In this manner, the insulated container 120 may permit the flow of cooled gas-form air from the container 120 to outlet 180.

Compressor 130 may be powered by gas or electricity. Compressor 130 may be one of a number of different types, including but not limited to positive displacement compressors such as reciprocating, rotary screw, or rotary sliding vane compressors. Compressor 130 may also be a dynamic compressor. Compressor 130 is coupled to the bottom portion or lower quadrant of the reservoir for container 120 so that when gas-form air is released from compressor 130, such air can push the liquid air 110 in an upward direction, thus causing both the gas-form air and liquid air to combine (the combination is sometimes referred to herein as “air”) and exit the insulated container as cooled gas-form air. This cooled gas-form air may be caused to flow toward the valve-controlled pipe 170.

Fan 140 may be used to draw the cooled air from the insulated container 120 to an outlet 180 via outlet pipe 175. Pipes 170 and 175 form a cooled air conduit along which cooled gas-form air may travel from the insulated container 120 to the outlet 180. It may be desirable for pipes 170, 175 to be sufficiently cold-resistant to withstand the low temperatures of the cooled gas-form air that traverses them without significant deformation. Cold-resistant pipes that are suitable for this type of application are known in the art.

The outlet 180 may include a duct system positioned in—or leading to—a room, building or other area or space for which cooling is desired. Fan 140 may be powered by electricity. Fan 140 may be any one of a number of different types of fans, including but not limited to axial and/or propeller fans, centrifugal (radial) fans, mixed flow fans, and cross flow fans. As far as axial and/or propeller fans are concerned, the fan may be a C wheel, A wheel or K wheel fan. For centrifugal (radial) fans, fan 140 may be an F wheel, B wheel, T wheel or P wheel, and the type of blade may be a straight steel plate paddle wheel, forward multi-vane multi-blade or a backward turbo-vane blade.

A temperature sensing device 190 may be disposed inside the room or building for which cooling is desired. Temperature sensing device 190 may be operably coupled to a power switch device 195. In this respect, when the room/building temperature has risen above a threshold that may have been specified by an end user, the temperature control device may cause the power switch device 195 to turn the cooling system to an ON state in order to cool the room/building. In this ON state, valves 150, 165 may remain open. Similarly, when the room/building temperature has dropped below a certain specified threshold, the temperature sensing device 190 may cause the power switch device 190 to turn the cooling system to an OFF state in order to stop or halt the process of cooling the room/building. In this OFF state, valves 150, 165 may be caused to close. Valves suitable for this type of application are known in the art.

The cooling system of the present disclosure can reduce the temperature in a space by a significant amount. In this connection, an experiment was conducted using the cooling system of the present disclosure. The cooling system was used to cool a room having a size of about 30 square meters (or 322 square feet). The insulated container 120 was filled with about 4 liters (or 1 gallon) of liquid air. Valve 165 was opened before valve 150 to avoid excessive pressure building up in the system. After both valves 150, 165 were fully opened for about three minutes, the temperature of the room decreased by about 50° C. (or 122° F.).

These results using the present cooling system were compared to a situation where a conventional residential portable air conditioner was used. Using this conventional residential portable air conditioner, the temperature of the room decreased by about 20° C. (or 68° F.) in about five minutes. Thus, when compared to the conventional residential portable air conditioner, the present cooling system showed a significantly increased capacity for cooling the room's air.

In FIG. 1, both a compressor 130 and fan 140 are used to circulate cooled gas-form air from the insulated container 120 to the outlet 180. However, it should be understood that other configurations could be devised without departing from the inventive concept. If either compressor 130 or the fan 140 had sufficient capacity to properly circulate the cooled gas-form air from the insulated container 120 to the outlet 180, only one of such air circulation devices would be necessary.

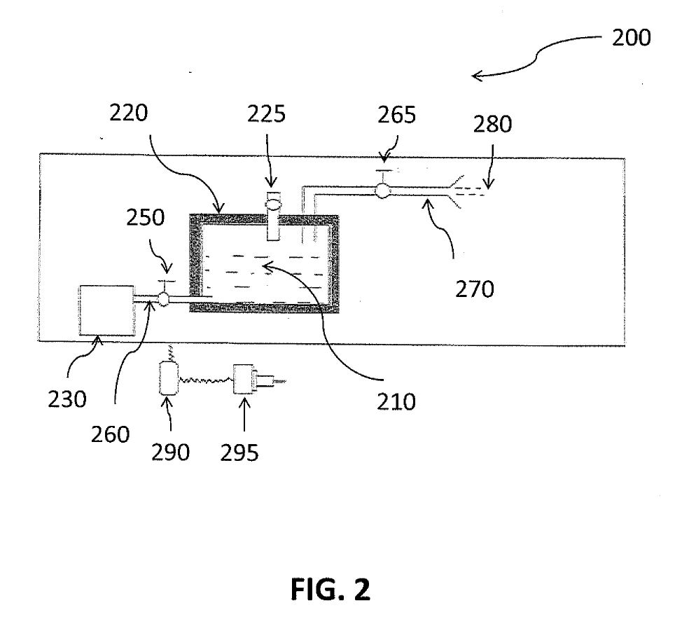

In this connection, referring now to FIG. 2, illustrated is a cooling system 200 in accordance with yet another embodiment of the present disclosure. As shown in FIG. 2, liquid air 210 is disposed in an insulated container 220. A first pipe 260 and valve 250 are operably coupled to the insulated container 220. The pipe 260 couples compressor 230 to the lower quadrant of the reservoir for insulated container 220. A liquid air introduction valve 225 permits the introduction of additional liquid air into the reservoir for insulated container 220. Control switch 295 may be used to turn off the system manually. In the alternative, the system may be automatically turned off when temperature sensing device 290 determines that the proper room temperature has been reached at outlet 280. Disposed between insulated container 220 and outlet 280 is a second valve 265 and pipe 270.

It should be noted that this embodiment does not include a fan. In this embodiment, the cooling system 200 includes only a compressor 230 as its air flow device. The compressor 230 must have sufficient capacity to push the cooled air from the cooling system to the outlet 280. From this outlet, the cooled gas-form air may travel into a room, building or other location for which cooling is desired. The size needed for the compressor 230 will depend upon a number of factors, including but not limited to, the size of the location for which cooling is desired.

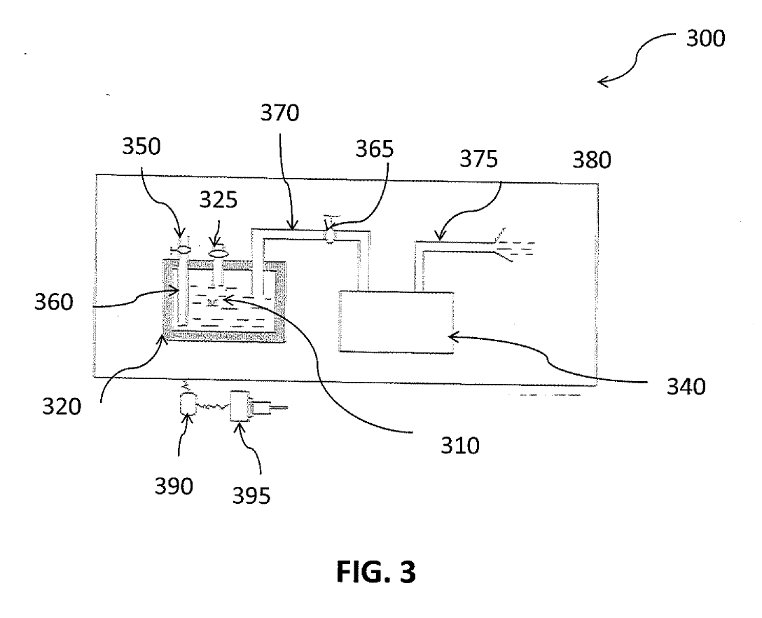

Referring now to FIG. 3, illustrated is a cooling system 300 in accordance with still yet another embodiment of the present disclosure. In this embodiment, the cooling system 300 includes only a fan 340 as its air flow device. The size needed for the fan 340 will depend upon a number of factors, including but not limited to, the size of the location for which cooling is desired.

FIG. 3 further includes liquid air 310 disposed in an insulated container 320. A first pipe 360 has an upper end that is disposed in—and capable of intaking—natural gas-form air from the environment outside the insulated container 320. Valve 350 is operably coupled to the lower quadrant of insulated container 320.

A liquid air introduction valve 325 permits the introduction of additional liquid air into the reservoir for insulated container 320. Control switch 395 may be used to turn off the system manually. In the alternative, the system may be automatically turned off when temperature sensing device 390 determines that the proper room temperature has been reached in the space or area disposed at outlet 380. Disposed between insulated container 320 and fan 340 is a second valve 365 and pipe 370. Pipe 375 is disposed between fan 340 and outlet 380.

It should be noted that this embodiment does not include a compressor. In this embodiment, the cooling system 300 includes only a fan 340 as its air flow device. The fan 340 must have sufficient capacity to pull or draw the cooled air from the cooling system 300 into the room, building or other location for which cooling is desired. The size needed for the fan 340 will depend upon a number of factors, including but not limited to, the size of the location for which cooling is desired.

While the specification describes particular embodiments of the present invention, those of ordinary skill can devise variations of the present invention without departing from the inventive concept.

We claim:

1. A non-toxic, energy efficient cooling system, comprising:
liquid air;
a container device configured to contain the liquid air and to maintain the liquid air in its liquefied form;
an outlet;
a cooled air conduit configured to provide a conduit for cooled gas-form air from the container device to the outlet; and
at least one air flow device configured to cause the flow of the cooled gas-form air from the container device to the outlet via the cooled air conduit; and
wherein, the container device is further configured to permit the flow of the cooled gas-form air from the container device to the outlet.

2. The cooling system of claim 1, wherein the container device includes insulation.

3. The cooling system of claim 2, wherein the insulation includes a flexible material that is wrapped around the container device.

4. The cooling system of claim 1, further comprising:
a liquid air introduction valve configured to permit the introduction of liquid air into the container.

5. The cooling system of claim 1, wherein the at least one air flow device includes a compressor device configured to introduce gas-form air into the container device, and wherein, the compressor device is operably coupled to the lower quadrant of the reservoir for the insulated container device.

6. The cooling system of claim 1, wherein the at least one air flow device includes a fan device configured to draw the liquid air from the container device to the outlet.

7. The cooling system of claim 1, wherein the at least one air flow device includes a compressor device configured to introduce gas-form air into the container device, and wherein, the compressor device is operably coupled to the lower quadrant of the reservoir for the insulated container device, and
wherein, the at least one air flow device further includes a fan device configured to draw the liquid air from the container device to the outlet.

8. The system of claim 1, wherein the cooled air conduit includes at least one cold-resistant pipe configured to withstand a temperature of the cooled gas-form air without deformation.

9 A non-toxic, energy efficient cooling system, comprising:
liquid air;
an insulated container device configured to contain the liquid air and to maintain the liquid air in its liquefied form;
an outlet;
a compressor device configured to introduce gas-form air into the insulated container device, thus causing some of the air in the insulated container device to rise and exit the container device as cooled gas-form air, the compressor being further configured to push the cooled gas-form air from the container device to the outlet, wherein the compressor device is coupled to the bottom quadrant of the reservoir for the insulated container device;
a cooled air conduit configured to provide a conduit without coils for the cooled gas-form air from the insulated container device to the outlet;
a fan device configured to draw the cooled gas-form air from the insulated container device to the outlet via the cooled air conduit;
at least two valve devices configured to permit the pushing and drawing of cooled gas-form air from the insulated container device to the outlet via the cooled air conduit; and
wherein, the insulated container device is further configured to provide sufficient capacity for the release of cooled gas-form air from the insulated container device.

10. The system of claim 9, wherein the insulated container device is a vacuum container, wherein the vacuum is disposed between an inner vessel and an outer vessel.

11. A non-toxic, energy efficient method for cooling an area, comprising the steps of:
providing liquid air in an insulated container; wherein the insulated container is configured to contain the liquid air and to maintain the liquid air in its liquefied form;
opening a first valve mechanism positioned on a first conduit segment between the insulated container and an outlet, thus permitting the flow of cooled gas-form air from the insulated container to the outlet;
opening a second valve mechanism positioned on a second conduit segment between a compressor and the insulated container, thus permitting the flow of air from the compressor to the insulated container;
causing the flow of the cooled gas-form air from the insulated container to the outlet, thus cooling an area located at the outlet.

12. The method of claim 11, wherein the causing step includes the step of:
introducing gas-form air into the insulated container with a compressor, thus causing at least a portion of the air in the insulated container device to rise and exit the container device as cooled gas-form air.

13. The method of claim 12, wherein the compressor is operably coupled to the bottom quadrant of the reservoir for the insulated container.

14. The method of claim 11, wherein the causing step includes the step of:
drawing the cooled gas-form air from the insulated container to the outlet with a fan disposed between the insulated container and outlet.

15. The method of claim 11, wherein the causing step includes the steps of:
introducing gas-form air into the insulated container with a compressor, thus causing at least a portion of the air in the insulated container device to rise and exit the container device as cooled gas-form air; and
drawing the cooled gas-form air from the insulated container to the outlet with a fan disposed between the insulated container and outlet.

16. The method of claim 10, wherein both the first conduit segment is sufficiently cold-resistant to withstand the temperature of the cooled gas-form air that passes therethrough without deformation.

17. The method of claim 10, further comprising the step of:
stopping the flow of the cooled gas-form air from the insulated container to the outlet when a temperature sensor senses that a desired temperature has been reached.

18. The method of claim 10, wherein the insulated container is further configured to provide sufficient capacity for the release of cooled gas-form air from the insulated container.
